(19) United States
(12) Patent Application Publication
(10) Pub. No.: US 2026/0307408 A1
(43) Pub. Date: Oct. 8, 2026

(54) WINDING DEVICE AND PRINTING APPARATUS

(71) Applicant: SEIKO EPSON CORPORATION, Tokyo (JP)

(72) Inventor: Manabu KONDO, MATSUMOTO-SHI (JP)

(21) Appl. No.: 19/462,083

(22) Filed: Jan. 28, 2026

(30) Foreign Application Priority Data
Jan. 31, 2025 (JP) 2025-014793

(51) Int. Cl. B41J 15/16; B41J 29/00

(52) U.S. Cl. CPC B41J 15/165; B41J 29/00

(57) ABSTRACT

A winding device includes a winding section configured to wind a medium for which intermittent conveyance for repeating one conveyance and stop is performed, a tension bar configured to apply tension to the medium wound by the winding section, a detection section configured to detect a position of the tension bar, a driving section configured to drive the winding section, and a control section configured to control the driving section. The control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar.

The present application is based on, and claims priority from JP Application Serial Number 2025-014793, filed Jan. 31, 2025, the disclosure of which is hereby incorporated by reference herein in its entirety.

### BACKGROUND

### 1. Technical Field

The present disclosure relates to a winding device and a printing apparatus.

### 2. Related Art

For example, JP-A-2017-74738 discloses a printing apparatus including a conveyance section including a conveyance roller that conveys a medium in a conveyance direction, a printing section that performs printing on the medium, a winding section that winds the printed medium, and a tension bar that applies tension to the medium. In the printing apparatus explained above, the winding section winds the medium in a period in which the conveyance of the conveyance section is stopped.

JP-A-2017-74738 is an example of the related art.

However, in the printing apparatus explained above, start and stop of winding are repeatedly performed according to intermittent conveyance of the medium. For this reason, it is likely that variation occurs in a binding force for the medium wound by the winding section.

### SUMMARY

According to an aspect of the present disclosure, there is provided a winding device including: a winding section configured to wind a medium for which intermittent conveyance for repeating one conveyance and stop is performed; a tension bar configured to apply tension to the medium wound by the winding section; a detection section configured to detect a position of the tension bar; a driving section configured to drive the winding section; and a control section configured to control the driving section, wherein the control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar.

According to an aspect of the present disclosure, there is provided a printing apparatus including: a conveyance section configured to perform intermittent conveyance for a medium for repeating one conveyance and stop; a printing section configured to perform printing on the medium in a state in which the medium is stopped; a winding section configured to wind the medium for which the intermittent conveyance is performed; a tension bar configured to apply tension to the medium wound by the winding section; a detection section configured to detect a position of the tension bar; a driving section configured to drive the winding section; and a control section configured to control the driving section, wherein the control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar.

### BRIEF DESCRIPTION OF THE DRAWINGS

FIG. 1 is a side view illustrating an example of a printing apparatus.

FIG. 2 is a graph illustrating changes in the position of a tension bar and driving speed of a driving section.

FIG. 3 is a graph illustrating changes in the position of the tension bar and the driving speed of the driving section.

FIG. 4 is a graph illustrating changes in the position of the tension bar and the driving speed of the driving section.

FIG. 5 is a flowchart illustrating winding control processing.

FIG. 6 is a flowchart illustrating peak processing.

FIG. 7 is a flowchart illustrating bottom processing.

FIG. 8 is a flowchart illustrating first position processing.

FIG. 9 is a flowchart illustrating second position processing.

### DESCRIPTION OF EMBODIMENTS

### First Embodiment

Hereinafter, a winding device and a printing apparatus according to an embodiment are explained with reference to the drawings.

### Configuration of a printing apparatus 11

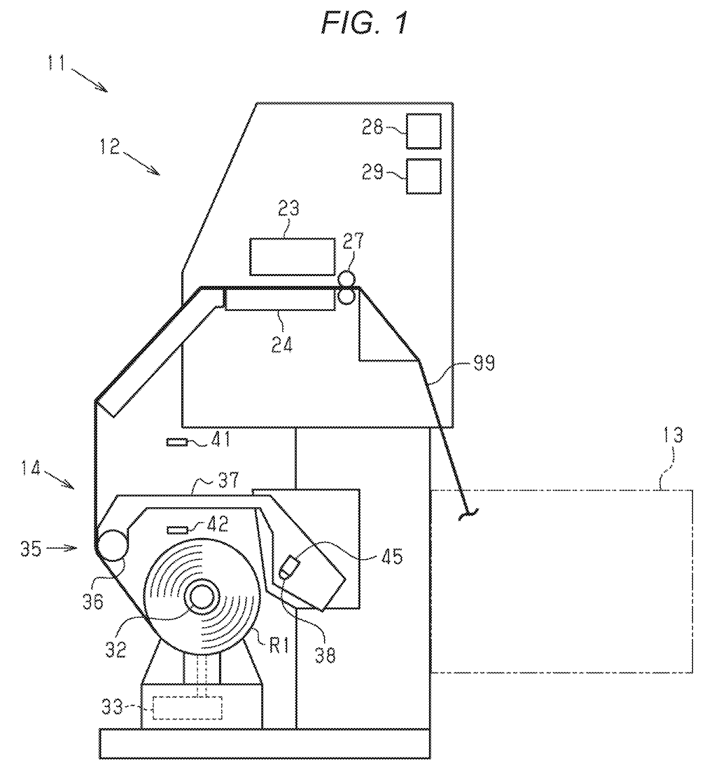

As illustrated in FIG. 1, the printing apparatus 11 is a printer that prints images such as characters and photographs by ejecting liquid onto a medium 99. The printing apparatus 11 may be an inkjet printer that ejects ink, which is an example of liquid, onto the medium 99. The printing apparatus 11 includes a printing unit 12. The printing unit 12 is configured to perform printing on the medium 99.

The printing apparatus 11 may include a letting-out unit 13. The letting-out unit 13 is configured to let out the medium 99. The letting-out unit 13 lets out the medium 99 toward the printing unit 12. The printing apparatus 11 may not include the letting-out unit 13 and may receive the medium 99 from a letting-out device that lets out the medium 99.

The printing apparatus 11 includes a winding unit 14. The winding unit 14 is equivalent to an example of a winding device. The winding unit 14 is configured to wind the medium 99. The winding unit 14 winds the printed medium 99 from the printing unit 12. The winding unit 14 forms a roll body R1 by winding the medium 99. The roll body R1 is an article obtained by rolling up the medium 99. The winding unit 14 may be configured as a winding device independent of the printing apparatus 11.

### Configuration of the printing unit 12

The printing unit 12 performs printing on the medium 99 let out from the letting-out unit 13. The medium 99 is printed by the printing unit 12 and thereafter wound by the winding unit 14. The printing unit 12 performs printing on the medium 99 from when the medium 99 is let out by the letting-out unit 13 until when the medium 99 is wound by the winding unit 14. The printing unit 12 performs printing on a long medium 99 extending from the letting-out unit 13 to the winding unit 14.

The printing unit 12 includes a printing section 23. That is, the printing apparatus 11 includes the printing section 23. The printing section 23 is configured to perform printing on the medium 99. The printing section 23 performs printing on the medium 99 in a state in which the medium 99 is stopped. The printing section 23 is a head that ejects liquid onto the medium 99. The printing section 23 is a serial head that scans the medium 99 but may be a line head.

The printing unit 12 includes a support section 24. The support section 24 supports the medium 99. The support section 24 faces the printing section 23. The support section 24 supports a region to be printed by the printing section 23 in the medium 99.

The printing unit 12 includes a conveyance section 27. That is, the printing apparatus 11 includes the conveyance section 27. The conveyance section 27 is configured to convey the medium 99. The conveyance section 27 conveys the medium 99 to the printing section 23. The conveyance section 27 conveys the medium 99 let out from the letting-out unit 13. The conveyance section 27 conveys the medium 99 from the letting-out unit 13 toward the winding unit 14. The conveyance section 27 may include, for example, a roller pair. In this case, the conveyance section 27 conveys the medium 99 by rotating the roller pair in a state of sandwiching the medium 99.

The conveyance section 27 intermittently conveys the medium 99. That is, the conveyance section 27 performs intermittent conveyance for the medium 99 for repeating one conveyance and stop. The conveyance section 27 stops the medium 99 while the printing section 23 ejects the liquid onto the medium 99. The conveyance section 27 conveys the medium 99 while the printing section 23 does not eject the liquid onto the medium 99. In the printing apparatus 11, the printing on the medium 99 and the conveyance of the medium 99 are alternately repeated.

The printing unit 12 includes a control section 28. That is, the printing apparatus 11 includes the control section 28. The control section 28 controls the printing unit 12. The control section 28 controls, for example, the printing section 23 and the conveyance section 27. The control section 28 is configured to control the letting-out unit 13. The control section 28 is configured to control the winding unit 14.

The control section 28 may include one or more processors that execute various kinds of processing according to a computer program. The control section 28 may include one or more dedicated hardware circuits such as an application specific integrated circuit that executes at least some of the various kinds of processing. The control section 28 may include a circuit including a combination of a processor and a hardware circuit. The processor includes a CPU and memories such as a RAM and a ROM. The memories store program codes or instructions configured to cause the CPU to perform processing. The memories, that is, computer readable media include any readable medium that can be accessed by a general-purpose or dedicated computer.

The printing unit 12 includes a storage section 29. The storage section 29 stores a variable indicating a state of the winding unit 14. The storage section 29 may store, besides the variable, a program to be executed by the control section 28. The storage section 29 may include a hard disk, a flash memory, or the like. The storage section 29 may be provided in the control section 28. The storage section 29 may include a RAM.

### Configuration of the winding unit 14

The winding unit 14 is attached to the printing unit 12. The winding unit 14 is located below the support section 24. For that reason, the winding unit 14 winds the medium 99 downward from the printing unit 12.

The winding unit 14 includes a winding section 32. That is, the printing apparatus 11 includes the winding section 32. The winding section 32 includes a winding shaft that supports the roll body R1. When the winding section 32 rotates, the medium 99 is wound by the winding section 32. That is, the winding section 32 winds the medium 99 for which intermittent conveyance is performed.

The winding unit 14 includes a driving section 33. That is, the printing apparatus 11 includes the driving section 33. The driving section 33 is configured to drive the winding section 32. The driving section 33 includes, for example, a motor. The driving section 33 is configured to transmit a driving force to the winding section 32. When the driving section 33 rotates the winding section 32, the medium 99 is wound by the winding section 32.

The driving section 33 is controlled by the control section 28. That is, the control section 28 controls the driving section 33. Specifically, the control section 28 controls driving speed of the driving section 33. Accordingly, the control section 28 controls rotation speed of the winding section 32. The control section 28 controls the rotation speed of the winding section 32 to adjust winding speed of the winding section 32 winding the medium 99.

The winding unit 14 includes a tension applying section 35. The tension applying section 35 is configured to apply tension to the medium 99. The tension applying section 35 applies tension to the medium 99 by coming into contact with the medium 99 from when the medium 99 is printed by the printing section 23 until when the medium 99 is wound by the winding section 32. When the tension applying section 35 applies appropriate tension to the medium 99, the medium 99 is smoothly wound from the printing unit 12 to the winding unit 14.

The tension applying section 35 includes a tension bar 36 and an arm 37. That is, the winding unit 14 includes the tension bar 36. The printing apparatus 11 includes the tension bar 36.

The arm 37 supports the tension bar 36. Specifically, the tension bar 36 is attached to a distal end portion of the arm 37. The arm 37 rotates centering on a turning shaft 38. The turning shaft 38 is provided at a proximal end portion of the arm 37. The arm 37 rotates to thereby displace the tension bar 36. That is, when the arm 37 rotates, the tension bar 36 moves in the up-down direction.

The tension bar 36 is supported by the distal end portion of the arm 37. The tension bar 36 is configured to be displaceable in the up-down direction when the arm 37 rotates. The tension bar 36 comes into contact with the medium 99. The medium 99 is wound on the tension bar 36. The tension bar 36 applies constant tension to the medium 99 with the own weight thereof. The tension bar 36 applies the constant tension to the medium 99 by being displaced in the up-down direction.

The tension bar 36 may be a roller. For that reason, the tension bar 36 rotates according to the medium 99 being wound. Accordingly, since the friction between the tension bar 36 and the medium 99 is reduced, the medium 99 is smoothly conveyed. The tension bar 36 may include, for example, an un-rotatable rod.

The tension bar 36 is displaced according to the difference between the conveyance speed of the medium 99 by the conveyance section 27 and the winding speed of the winding section 32. The winding speed of the winding section 32 can be adjusted by the rotation speed of the winding section 32. The winding speed of the winding section 32 is speed proportional to the rotation speed of the winding section 32. The rotation speed of the winding section 32 is speed corresponding to the driving speed of the driving section 33. The rotation speed of the winding section 32 is speed proportional to the driving speed of the driving section 33.

Specifically, when the medium 99 is conveyed by the conveyance section 27, the medium 99 is slacked by the conveyance section 27 when the conveyance speed of the medium 99 by the conveyance section 27 is higher than the winding speed of the winding section 32. Accordingly, the tension bar 36 moves downward.

When the conveyance by the conveyance section 27 is stopped, the winding speed of the winding section 32 is higher than the conveyance speed of the medium 99 by the conveyance section 27. In this case, the winding section 32 pulls the medium 99. Accordingly, the tension bar 36 moves upward.

The tension applying section 35 includes an upper stopper 41. That is, the winding unit 14 includes the upper stopper 41. The printing apparatus 11 includes the upper stopper 41. The upper stopper 41 is configured to restrict the movement of the tension bar 36. The upper stopper 41 restricts the upward movement of the tension bar 36 by coming into contact with the tension bar 36 or the arm 37. In one example, the upper stopper 41 comes into contact with the tension bar 36 from above. The upper stopper 41 restricts the tension bar 36 from moving upward.

The tension applying section 35 includes a lower stopper 42. That is, the winding unit 14 includes the lower stopper 42. The printing apparatus 11 includes the lower stopper 42. The lower stopper 42 is configured to restrict the movement of the tension bar 36. The lower stopper 42 restricts downward movement of the tension bar 36 by coming into contact with the tension bar 36 or the arm 37. In one example, the lower stopper 42 comes into contact with the tension bar 36 from below. The lower stopper 42 restricts the tension bar 36 from moving downward.

The upper stopper 41 and the lower stopper 42 are located to hold the tension bar 36 above and below the tension bar 36. A movement range of the tension bar 36 is between the upper stopper 41 and the lower stopper 42.

The tension applying section 35 includes a detection section 45. That is, the winding unit 14 includes the detection section 45. The printing apparatus 11 includes the detection section 45. The detection section 45 is configured to detect the position of the tension bar 36 at every fixed period. The detection section 45 detects the position of the tension bar 36 by detecting a rotation angle of the arm 37. For example, the detection section 45 includes a not-illustrated encoder.

The control section 28 is capable of carrying out, based on the position of the tension bar 36 detected by the detection section 45, driving speed adjustment for adjusting the driving speed of the driving section 33. Accordingly, the control section 28 continuously drives the winding section 32 while the intermittent conveyance for the medium 99 is repeated and controls the driving section 33 to reduce variation that occurs in a binding force of the medium 99.

When the position of the tension bar 36 is detected by the encoder, a reference angle of the arm 37 serving as a measurement reference of the encoder is necessary. The detection section 45 detects the rotation angle of the arm 37 by counting encoder pulses from the reference angle. The reference angle may be stored in advance in the control section 28, the storage section 29, or the like.

### Control of the printing apparatus 11

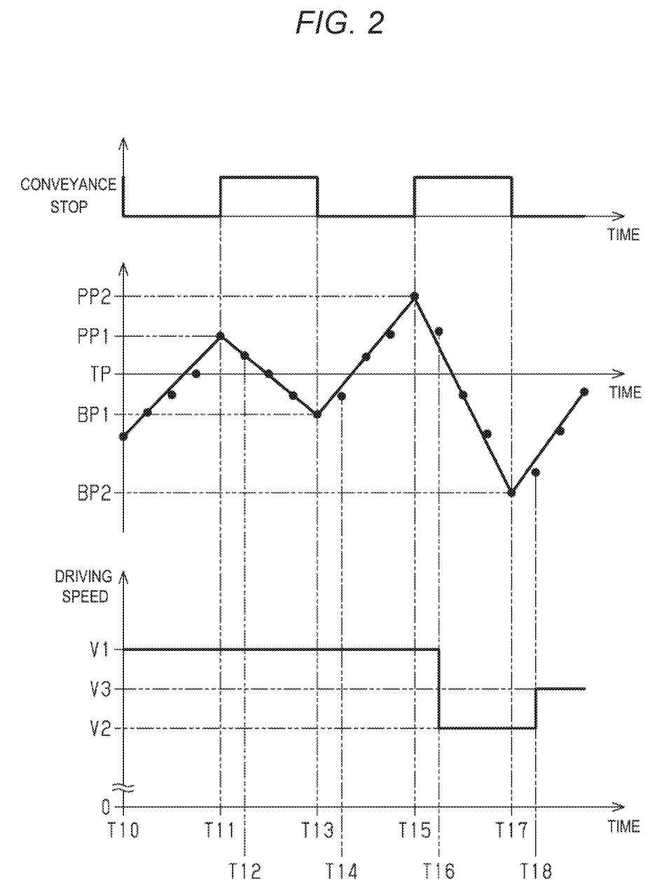

Here, an overview of control of the printing apparatus 11 is explained with reference to FIGS. 2 to 4. In the figures, a conveyance form of the medium 99 is illustrated in an upper part. In the figures, the position of the tension bar 36 is illustrated in a middle part. In the figures, the driving speed of the driving section 33 is illustrated in a lower part. In the figures, an actual position of the tension bar 36 is indicated by a straight line. In the figures, detection positions of the tension bar 36 by the detection section 45 are indicated by dots.

As illustrated in FIG. 2, in the printing apparatus 11, the winding section 32 is capable of continuously rotating with the driving section 33 while the intermittent conveyance for the medium 99 is performed by the conveyance section 27. In the intermittent conveyance, the tension bar 36 is displaced in the up-down direction.

Specifically, when the conveyance of the medium 99 by the conveyance section 27 is stopped, the winding speed of the winding section 32 is higher than the conveyance speed of the medium 99 by the conveyance section 27. Accordingly, when the winding section 32 pulls the medium 99, the tension bar 36 moves upward.

When the medium 99 is conveyed by the conveyance section 27, the winding speed of the winding section 32 is lower than the conveyance speed of the medium 99 by the conveyance section 27. Accordingly, since the medium 99 slacks, the tension bar 36 moves downward.

As explained above, while the intermittent conveyance for the medium 99 is performed by the conveyance section 27, since the winding section 32 continuously winds the medium 99 at the winding speed lower than the conveyance speed, the tension bar 36 moves in the up-down direction. In particular, when the conveyance of the medium 99 by the conveyance section 27 is started, the position of the tension bar 36 reaches a peak position. The peak position is a turning point at which a moving direction of the position of the tension bar 36 changes from upward to downward. The peak position can be detected based on the positions of the tension bar 36 at least at three points in chronological order.

When the conveyance of the medium 99 by the conveyance section 27 is stopped, the position of the tension bar 36 reaches a bottom position. The bottom position is a turning point at which the moving direction of the position of the tension bar 36 changes from downward to upward. The bottom position can be detected based on the positions of the tension bar 36 at least at three points in chronological order.

The rotation speed of the winding section 32 can be adjusted such that the position of the tension bar 36 approaches a target position TP. The target position TP is a position serving as a transition guide for the tension bar 36. The target position TP may be stored in the storage section 29. The target position TP may be input from a not-illustrated operation section by a user.

Specifically, when a current peak position is higher than a last peak position, since the winding speed is higher compared with the conveyance speed, the position of the tension bar 36 is likely to continue to be displaced further upward than the target position TP. For that reason, when the position of the tension bar 36 is higher than the target position TP and the current peak position is higher than the last peak position, the rotation speed of the winding section 32 is reduced. When the current bottom position is lower than the last bottom position, since the winding speed is lower compared with the conveyance speed, the position of the tension bar 36 is likely to continue to be displaced further downward than the target position TP. For that reason, when the position of the tension bar 36 is lower than the target position TP and the current bottom position is lower than the last bottom position, the rotation speed of the winding section 32 is increased.

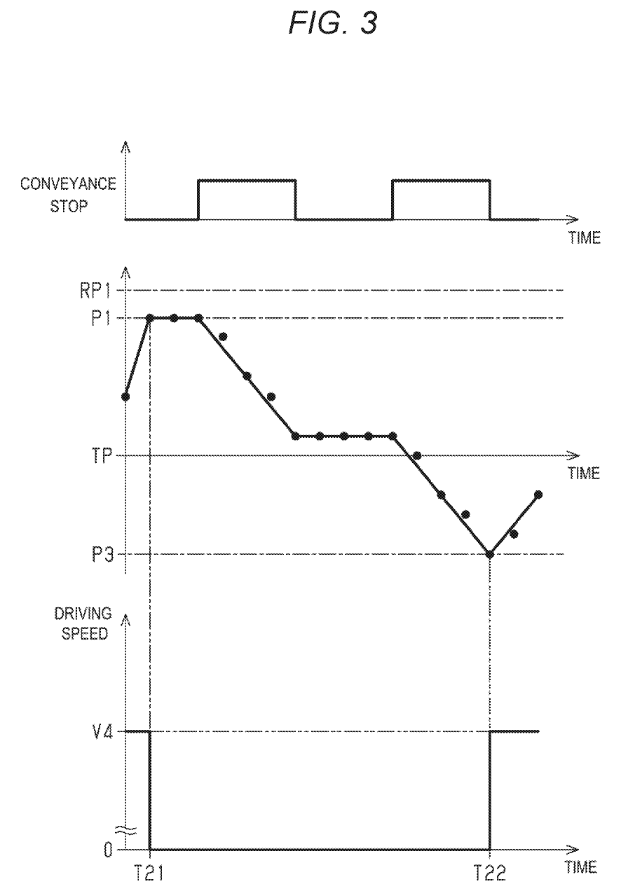

As illustrated in FIG. 3, when the position of the tension bar 36 is equal to or higher than a first position P1, the rotation of the winding section 32 is stopped. By stopping the rotation of the winding section 32, the position of the tension bar 36 is prevented from continuing to rise higher than the first position P1. The first position P1 is higher than the target position TP. The first position P1 is lower than a first restriction position RP1. The first restriction position RP1 is a position where the tension bar 36 is prevented from moving upward by being restricted by the upper stopper 41. The first restriction position RP1 is the uppermost position in the movement range of the tension bar 36. When the tension bar 36 reaches the first restriction position RP1, it is difficult to apply appropriate tension.

Thereafter, when the position of the tension bar 36 is equal to or lower than a third position P3 in a state in which the rotation of the winding section 32 is stopped, the rotation of the winding section 32 is resumed. By resuming the rotation of the winding section 32, the position of the tension bar 36 is prevented from continuing to fall lower than the third position P3. The third position P3 is lower than the target position TP. The third position P3 is higher than the second restriction position RP2. The second restriction position RP2 is a position where the tension bar 36 is prevented from moving downward by being restricted by the lower stopper 42. The second restriction position RP2 is the lowermost position in the movement range of the tension bar 36. When the tension bar 36 reaches the second restriction position RP2, it is difficult to apply appropriate tension.

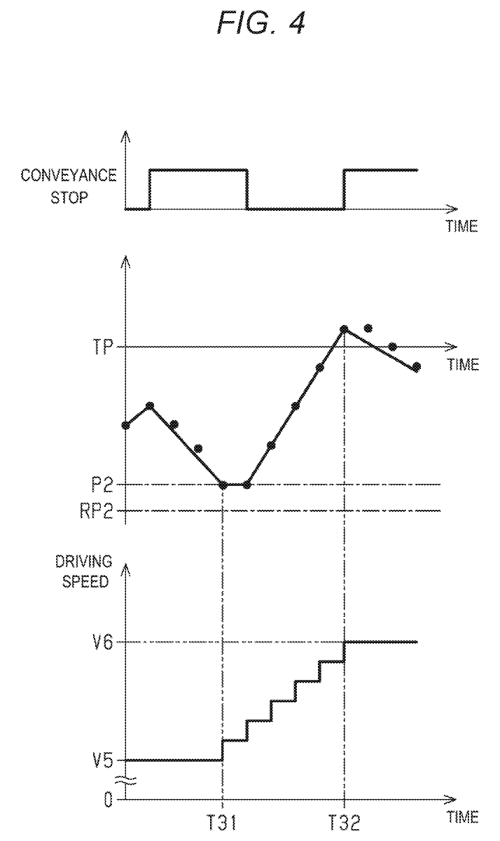

As illustrated in FIG. 4, when the position of the tension bar 36 is equal to or lower than a second position P2, the rotation speed of the winding section 32 is increased stepwise. The second position P2 is lower than the target position TP. The second position P2 is higher than the second restriction position RP2. The second position P2 is lower than the third position P3. When the position of the tension bar 36 reaches the second position P2, since it is likely that the winding speed is lower than necessary winding speed, the rotation speed of the winding section 32 is increased.

As explained above, as illustrated in FIG. 2, the position of the tension bar 36 is controlled to approach the target position TP. Even when the conveyance speed does not change and the rotation speed of the winding section 32 is kept constant, a winding amount of the medium 99 changes when the diameter of the roll body R1 changes. Therefore, the winding speed changes. It is necessary to control the rotation speed of the winding section 32 according to a state in which the position of the tension bar 36 changes. It is preferable that the peak position and the bottom position of the tension bar 36 stably swing at constant height. Accordingly, it is possible to reduce the number of times of changing the rotation speed of the winding section 32.

Even when the control explained above is performed, when the position of the tension bar 36 is equal to or higher than the first position P1 as illustrated in FIG. 3, the rotation of the winding section 32 is stopped. When the position of the tension bar 36 is equal to or lower than the second position P2 as illustrated in FIG. 4, the rotation speed of the winding section 32 increases stepwise.

### Winding control processing

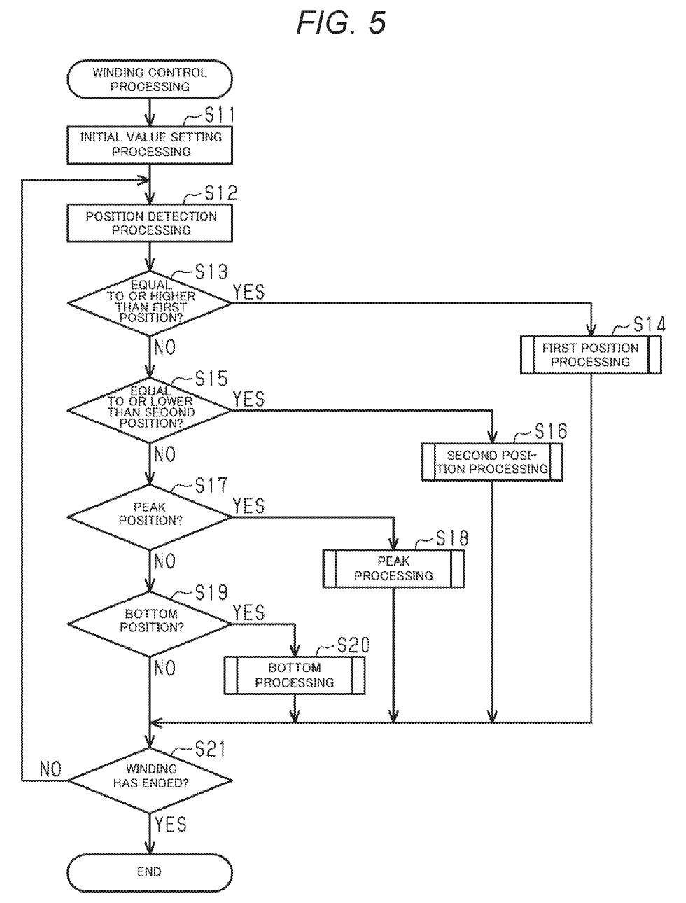

Next, winding control processing is explained with reference to FIG. 5. The winding control processing is executed by the control section 28 when a printing start instruction of the user is input.

As illustrated in FIG. 5, in step S11, the control section 28 executes initial value setting processing. In the initial value setting processing, the control section 28 reads an initial reference peak position stored in the storage section 29. The initial reference peak position is a position equal to or higher than the target position TP and may be a standard peak position. The control section 28 sets the initial reference peak position as a reference peak position of the tension bar 36 allocated to the storage section 29.

The control section 28 reads an initial reference bottom position stored in the storage section 29. The initial reference bottom position is a position equal to or lower than the target position TP and may be a standard bottom position. The control section 28 sets the initial reference bottom position as a reference bottom position of the tension bar 36 allocated to the storage section 29.

The control section 28 sets invalid data as the last driving speed allocated to the storage section 29. The last driving speed is data indicating last time driving speed. The last time driving speed is driving speed before being adjusted to the current driving speed. The last time driving speed or the invalid data is set as the last driving speed.

The control section 28 sets the invalid data in the last change flag allocated to the storage section 29. The last change flag is a flag indicating, when the driving speed of the driving section 33 was adjusted last time, whether the adjustment is due to the peak position or due to the bottom position. In the last change flag, any one of data indicating the peak position, data indicating the bottom position, and the invalid data is set.

The control section 28 reads initial driving speed stored in the storage section 29. The initial driving speed may be standard driving speed. The control section 28 sets the initial driving speed as the driving speed of the driving section 33. Accordingly, the control section 28 drives the driving section 33.

In step S12, the control section 28 executes position detection processing. In the position detection processing, the control section 28 detects the position of the tension bar 36 based on a detection signal of the detection section 45. The control section 28 stores the position of the tension bar 36 in the storage section 29 as a history.

In step S13, the control section 28 determines whether the position of the tension bar 36 is equal to or higher than the first position P1. When determining that the position of the tension bar 36 is equal to or higher than the first position P1, the control section 28 shifts the processing to step S14. When determining that the position of the tension bar 36 is not equal to or higher than the first position P1, the control section 28 shifts the processing to step S15.

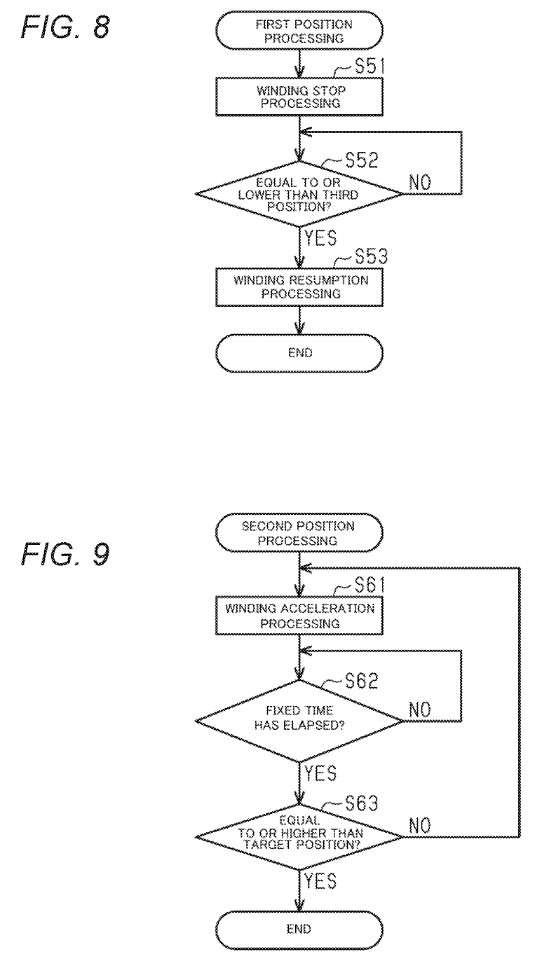

In step S14, the control section 28 executes first position processing. The first position processing is explained below with reference to FIG. 8. The control section 28 controls the driving section 33 such that the position of the tension bar 36 is not equal to or higher than the first position P1.

In step S15, the control section 28 determines whether the position of the tension bar 36 is equal to or lower than the second position P2. When determining that the position of the tension bar 36 is equal to or lower than the second position P2, the control section 28 shifts the processing to step S16. When determining that the position of the tension bar 36 is not equal to or lower than the second position P2, the control section 28 shifts the processing to step S17.

In step S16, the control section 28 executes second position processing. The second position processing is explained below with reference to FIG. 9. The control section 28 controls the driving section 33 such that the position of the tension bar 36 is not equal to or lower than the second position P2.

In step S17, the control section 28 determines whether the position of the tension bar 36 has reached the peak position. Specifically, when the position of the tension bar 36 has risen and thereafter fallen, the control section 28 determines, based on at least most recent three positions of the tension bar 36, that the position of the tension bar 36 has reached the peak position. As explained above, the control section 28 detects the peak position of the tension bar 36 based on the position of the tension bar 36.

When determining that the position of the tension bar 36 has reached the peak position, the control section 28 shifts the processing to step S18. When determining that the position of the tension bar 36 has not reached the peak position, the control section 28 shifts the processing to step S19.

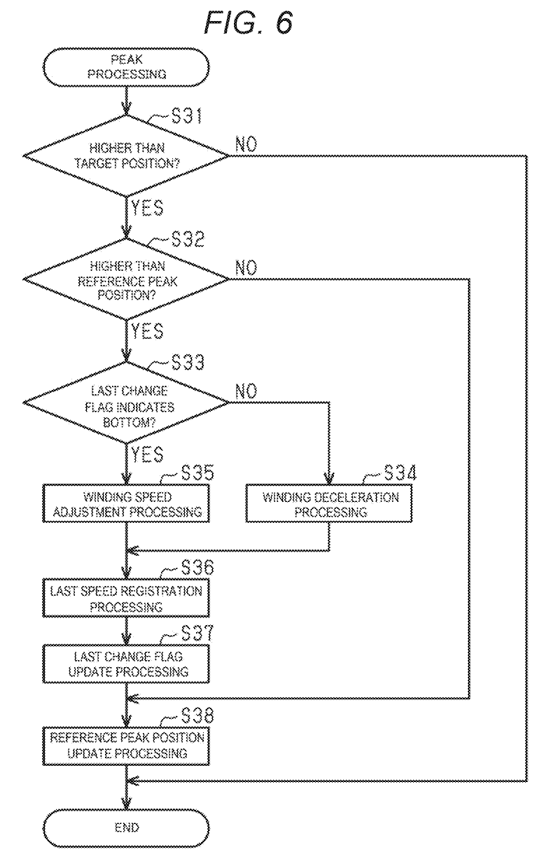

In step S18, the control section 28 executes peak processing. The peak processing is explained below with reference to FIG. 6. The control section 28 controls the driving section 33 to bring the position of the tension bar 36 close to the target position TP.

In step S19, the control section 28 determines whether the position of the tension bar 36 has reached the bottom position. Specifically, when the position of the tension bar 36 has fallen and thereafter risen, the control section 28 determines, based on at least most recent three positions of the tension bar 36, that the position of the tension bar 36 has reached the bottom position. As explained above, the control section 28 detects the bottom position of the tension bar 36 based on the position of the tension bar 36.

When determining that the position of the tension bar 36 has reached the bottom position, the control section 28 shifts the processing to step S20. When determining that the position of the tension bar 36 has not reached the bottom position, the control section 28 shifts the processing to step S21.

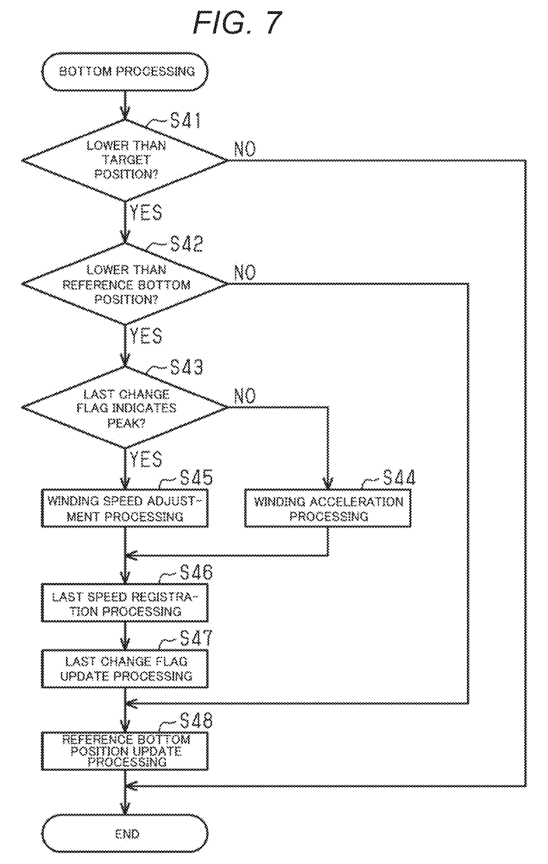

In step S20, the control section 28 executes bottom processing. The bottom processing is explained below with reference to FIG. 7. The control section 28 controls the driving section 33 to bring the position of the tension bar 36 close to the target position TP.

In step S21, the control section 28 determines whether the winding of the medium 99 by the winding section 32 has ended. When a printing end instruction of the user is input, the control section 28 may determine that the winding of the medium 99 by the winding section 32 has ended.

When determining that the winding of the medium 99 has ended, the control section 28 ends the position monitoring processing. When determining that the winding of the medium 99 has not ended, the control section 28 shifts the processing to step S12. Accordingly, the control section 28 repeatedly executes steps S12 to S21 until the winding of the medium 99 ends.

### Peak processing

Next, the peak processing is explained with reference to FIG. 6. The peak processing is executed by the control section 28 in step S18 of the winding control processing.

As illustrated in FIG. 6, in step S31, the control section 28 determines whether the current peak position is higher than the target position TP. When determining that the current peak position is equal to or lower than the target position TP, the control section 28 ends the peak processing. When determining that the current peak position is higher than the target position TP, the control section 28 shifts the processing to step S32.

In step S32, the control section 28 reads the reference peak position of the tension bar 36 allocated to the storage section 29 and determines whether the current peak position is higher than the reference peak position. When determining that the current peak position is equal to or lower than the reference peak position, the control section 28 shifts the processing to step S38. When determining that the current peak position is higher than the reference peak position, the control section 28 shifts the processing to step S33.

In step S33, the control section 28 determines whether data indicating the bottom is set in the last change flag. When determining that the data indicating the bottom is not set in the last change flag, the control section 28 shifts the processing to step S34. When determining that the data indicating the bottom is set in the last change flag, the control section 28 shifts the processing to step S35.

In step S34, the control section 28 executes winding deceleration processing. In the winding deceleration processing, the control section 28 reduces the driving speed of the driving section 33 by predetermined speed. The predetermined speed may be, for example, 5% of the current driving speed of the driving section 33.

As explained above, when adjusting the driving speed of the driving section 33 to low driving speed in the last time and adjusting the driving speed of the driving section 33 to low driving speed in this time, the control section 28 adjusts the driving speed of the driving section 33 to driving speed lower than the current driving speed by predetermined speed.

In step S35, the control section 28 executes winding speed adjustment processing. In the winding speed adjustment processing, the control section 28 sets, as new driving speed of the driving section 33, speed obtained by averaging the current driving speed and the last driving speed of the driving section 33.

As explained above, when adjusting the driving speed of the driving section 33 to high driving speed in the last time and adjusting the driving speed of the driving section 33 to low driving speed in this time, the control section 28 adjusts average speed of the last driving speed and the current driving speed as the driving speed. In other words, when adjusting the driving speed of the driving section 33, the control section 28 adjusts the driving speed to the average speed of the last driving speed and the current driving speed when whether the driving speed of the driving section 33 is reduced or increased is different compared with when the driving speed of the driving section 33 was adjusted last time.

Accordingly, when the current peak position is a position higher than the target position TP and the current peak position is a position higher than the last peak position, the control section 28 can adjust the driving speed of the driving section 33 to driving speed lower than the current driving speed.

In step S36, the control section 28 executes last speed registration processing. In the last speed registration processing, the control section 28 registers driving speed before being adjusted in steps S34 and S35 in the storage section 29 as the last driving speed.

In step S37, the control section 28 executes last change flag update processing. In the last change flag update processing, the control section 28 updates the last change flag by setting data indicating the peak position in the last change flag.

In step S38, the control section 28 executes reference peak position update processing. In the reference peak position update processing, the control section 28 updates the current peak position as the reference peak position regardless of whether the driving speed of the driving section 33 has been adjusted.

### Bottom processing

Next, the bottom processing is explained with reference to FIG. 7. The bottom processing is executed by the control section 28 in step S20 of the winding control processing.

As illustrated in FIG. 7, in step S41, the control section 28 determines whether the current bottom position is lower than the target position TP. When determining that the current bottom position is equal to or higher than the target position TP, the control section 28 ends the bottom processing. When determining that the current bottom position is lower than the target position TP, the control section 28 shifts the processing to step S42.

In step S42, the control section 28 reads the reference bottom position of the tension bar 36 allocated to the storage section 29 and determines whether the current bottom position is lower than the reference bottom position. When determining that the current bottom position is equal to or higher than the reference bottom position, the control section 28 shifts the processing to step S48. When determining that the current bottom position is lower than the reference bottom position, the control section 28 shifts the processing to step S43.

In step S43, the control section 28 determines whether data indicating a peak is set in the last change flag. When determining that the data indicating the peak is not set in the last change flag, the control section 28 shifts the processing to step S44. When determining that the data indicating the peak is set in the last change flag, the control section 28 shifts the processing to step S45.

In step S44, the control section 28 executes winding acceleration processing. In the winding acceleration processing, the control section 28 increases the driving speed of the driving section 33 by predetermined speed. The predetermined speed may be, for example, 5% of the current driving speed of the driving section 33.

As explained above, when adjusting the driving speed of the driving section 33 to high driving speed in the last time and adjusting the driving speed of the driving section 33 to high driving speed in this time, the control section 28 adjusts the driving speed of the driving section 33 to driving speed higher than the current driving speed by predetermined speed.

In step S45, the control section 28 executes the winding speed adjustment processing. In the winding speed adjustment processing, the control section 28 sets, as new driving speed of the driving section 33, speed obtained by averaging the current driving speed and the last driving speed of the driving section 33.

As explained above, when adjusting the driving speed of the driving section 33 to low driving speed in the last time and adjusting the driving speed of the driving section 33 to high driving speed in this time, the control section 28 adjusts average speed of the last driving speed and the current driving speed as the driving speed. In other words, when adjusting the driving speed of the driving section 33, the control section 28 adjusts the driving speed to the average speed of the last driving speed and the current driving speed when whether the driving speed of the driving section 33 is reduced or increased is different compared with when the driving speed of the driving section 33 was adjusted last time.

Accordingly, when the current bottom position is a position lower than the target position TP and the current bottom position is a position lower than the last bottom position, the control section 28 can adjust the driving speed of the driving section 33 to driving speed higher than the current driving speed.

In step S46, the control section 28 executes the last speed registration processing. In the last speed registration processing, the control section 28 registers the driving speed before being adjusted in steps S44 and S45 in the storage section 29 as the last driving speed.

In step S47, the control section 28 executes the last change flag update processing. In the last change flag update processing, the control section 28 updates the last change flag by setting data indicating the bottom position in the last change flag.

In step S48, the control section 28 executes reference bottom position update processing. In the reference bottom position update processing, the control section 28 updates the current bottom position as the reference bottom position regardless of whether the driving speed of the driving section 33 has been adjusted.

As explained above, while the intermittent conveyance for the medium 99 is performed, the control section 28 continuously drives the driving section 33 at driving speed adjusted based on the position of the tension bar 36 in a state in which the tension bar 36 applies tension to the medium 99.

### First position processing

Next, the first position processing is explained with reference to FIG. 8. The first position processing is executed by the control section 28 in step S14 of the winding control processing.

As illustrated in FIG. 8, in step S51, the control section 28 executes winding stop processing. In the winding stop processing, the control section 28 stops the driving of the driving section 33. As explained above, when determining that the position of the tension bar 36 is equal to or higher than the first position P1, the control section 28 stops the driving of the driving section 33.

In step S52, the control section 28 determines whether the position of the tension bar 36 is equal to or lower than the third position P3. When determining that the position of the tension bar 36 is not equal to or lower than the third position P3, the control section 28 shifts the processing to step S52 again. When determining that the position of the tension bar 36 is equal to or lower than the third position P3, the control section 28 shifts the processing to step S53. As explained above, the control section 28 stops the driving of the driving section 33 until the control section 28 determines that the position of the tension bar 36 is equal to or lower than the third position P3.

In step S53, the control section 28 executes winding resumption processing. In the winding resumption processing, the control section 28 restarts the driving of the driving section 33. As explained above, when determining that the position of the tension bar 36 is equal to or lower than the third position P3 in a state in which the driving of the driving section 33 is stopped, the control section 28 resumes the driving of the driving section 33.

In particular, when determining that the position of the tension bar 36 is equal to or lower than the third position P3 in a state in which the driving of the driving section 33 is stopped, the control section 28 may resume the driving of the driving section 33 at the same driving speed as the driving speed before the driving of the driving section 33 is stopped.

### Second position processing

Next, the second position processing is explained with reference to FIG. 9. The second position processing is executed by the control section 28 in step S16 of the winding control processing.

As illustrated in FIG. 9, in step S61, the control section 28 executes the winding acceleration processing. In the winding acceleration processing, the control section 28 increases the driving speed of the driving section 33. As described above, when determining that the position of the tension bar 36 is equal to or lower than the second position P2, the control section 28 increases the driving speed of the driving section 33. The control section 28 may increase the driving speed of the driving section 33 by predetermined speed.

In step S62, the control section 28 determines whether a fixed time has elapsed. The control section 28 may determine any interrupt interval of the control section 28 as the fixed time. When determining that the fixed time has not elapsed, the control section 28 shifts the processing to step S62 again. When determining that the fixed time has elapsed, the control section 28 shifts the processing to step S63.

In step S63, the control section 28 determines whether the position of the tension bar 36 is equal to or higher than the target position TP. When determining that the position of the tension bar 36 is equal to or higher than the target position TP, the control section 28 ends the second position processing. When determining that the position of the tension bar 36 is lower than the target position TP, the control section 28 shifts the processing to step S61. As explained above, the control section 28 increases the driving speed of the driving section 33 stepwise until the control section 28 determines that the position of the tension bar 36 is equal to or higher than the target position TP.

In this way, the control section 28 controls the driving of the winding section 32 by controlling the driving section 33. As a result of performing the control as explained above, the driving speed of the driving section 33 reaches speed corresponding to a conveyance amount of the medium 99 in one intermittent conveyance and an interval of the one intermittent conveyance. In particular, a winding amount per unit time in which the medium 99 is wound by the winding section 32 is smaller than a conveyance amount of the medium 99 per unit time. The winding amount per unit time is an amount corresponding to the diameter of the roll body R1 and a driving amount per unit time of the driving section 33. That is, the winding amount of the winding section 32 is proportional to the driving amount of the driving section 33. However, a constant of proportionality changes according to a change in the diameter of the roll body R1. For that reason, winding speed, which is the winding amount per unit time, also reaches speed corresponding to the diameter of the roll body R1 and the driving speed of the driving section 33.

### Specific control of the printing apparatus 11

Next, a specific example of control of the printing apparatus 11 is explained.

As illustrated in FIG. 2, at the timing indicated by reference sign T10, the conveyance of the medium 99 by the conveyance section 27 is stopped as the intermittent conveyance of the medium 99 by the conveyance section 27. The driving speed of the driving section 33 is first speed V1. Accordingly, the position of the tension bar 36 rises.

The conveyance of the medium 99 by the conveyance section 27 is started at the timing indicated by reference sign T11. Thereafter, the tension bar 36 falls and it is detected, at the timing indicated by reference sign T12, based on at least most recent three positions of the tension bar 36, that the position of the tension bar 36 has reached a first peak position PP1. When the first peak position PP1 is higher than the target position TP but is lower than the reference peak position, the driving speed of the driving section 33 is continued at the first speed V1. The reference peak position is updated to the first peak position PP1.

The conveyance of the medium 99 by the conveyance section 27 is stopped at the timing indicated by reference sign T13. Thereafter, the tension bar 36 rises and it is detected, at the timing indicated by reference sign T14, based on at least most recent three positions of the tension bar 36, that the position of the tension bar 36 has reached a first bottom position BP1. When the first bottom position BP1 is lower than the target position TP but is higher than the reference bottom position, the driving speed of the driving section 33 is continued at the first speed V1. The reference bottom position is updated to the first bottom position BP1.

The conveyance of the medium 99 by the conveyance section 27 is started at the timing indicated by reference sign T15. Thereafter, the tension bar 36 falls and it is detected, at the timing indicated by reference sign T16, based on at least most recent three positions of the tension bar 36, that the position of the tension bar 36 has reached a second peak position PP2. When the second peak position PP2 is higher than the target position TP and is higher than the first peak position PP1, which is the reference peak position, and the last change flag is not data indicating the bottom position, the driving speed of the driving section 33 is reduced by predetermined speed from the first speed V1. Accordingly, the driving speed of the driving section 33 reaches second speed V2. The reference peak position is updated to the second peak position PP2. The last change flag is updated to data indicating the peak position.

The conveyance of the medium 99 by the conveyance section 27 is stopped at the timing indicated by reference sign T17. Thereafter, the tension bar 36 rises and it is detected, at the timing indicated by reference sign T18, based on at least most recent three positions of the tension bar 36, that the position of the tension bar 36 has reached a second bottom position BP2. When the second bottom position BP2 is lower than the target position TP and is lower than the first bottom position BP1, which is the reference bottom position, and the last change flag is data indicating the peak position, the driving speed of the driving section 33 is adjusted to third speed V3. The third speed V3 is average speed of the first speed V1, which is the last driving speed, and the second speed V2, which is the current driving speed.

As illustrated in FIG. 3, at the timing indicated by reference sign T21, the driving speed of the driving section 33 is fourth speed V4. When the position of the tension bar 36 is equal to or higher than the first position P1 at the timing indicated by reference sign T21, the driving by the driving section 33 is stopped and the driving speed of the driving section 33 decreases to 0. Accordingly, the position of the tension bar 36 falls.

When the position of the tension bar 36 is equal to or lower than the third position P3 at the timing indicated by reference sign T22, the driving by the driving section 33 is resumed. Accordingly, the position of the tension bar 36 rises. The driving speed of the driving section 33 reaches the fourth speed V4 before the winding stop.

As illustrated in FIG. 4, at the timing indicated by reference sign T31, the driving speed of the driving section 33 is fifth speed V5. When the position of the tension bar 36 is equal to or lower than the second position P2 at the timing indicated by reference sign T31, the driving speed of the driving section 33 is increased stepwise. Thereafter, when the position of the tension bar 36 is equal to or higher than the target position TP at the timing indicated by reference sign T32, the driving speed of the driving section 33 becomes constant at sixth speed V6 at that point in time.

### Action and effects of the first embodiment

Action and effects of the first embodiment are explained.
(1) The control section 28 is capable of carrying out, based on the position of the tension bar 36 detected by the detection section 45, the driving speed adjustment for adjusting the driving speed of the driving section 33. While the intermittent conveyance for the medium 99 is performed, in a state in which the tension bar 36 applies tension to the medium 99, the control section 28 continuously drives the driving section 33 at the driving speed adjusted based on the position of the tension bar 36. With this configuration, even while the intermittent conveyance for repeating one conveyance and stop is performed, it is possible to prevent start and stop of winding of the medium 99 from being repeatedly performed. Therefore, it is possible to reduce variation that occurs in a binding force of the medium 99.
(2) The driving speed of the driving section 33 is speed corresponding to a conveyance amount of the medium 99 in one intermittent conveyance and an interval of the one intermittent conveyance. With this configuration, the medium 99 can be wound at speed corresponding to the conveyance amount of the medium 99 in the one intermittent conveyance and the interval of the one intermittent conveyance.
(3) A winding amount per unit time in which the medium 99 is wound by the winding section 32 is smaller than a conveyance amount of the medium 99 per unit time. With this configuration, even when the intermittent conveyance is performed for a long time, it is possible to reduce excessive winding of the medium 99 by the winding section 32 when the conveyance of the medium 99 is stopped. Accordingly, it is possible to prevent start and stop of winding of the medium 99 from being repeatedly performed. Therefore, it is possible to reduce variation that occurs in a binding force of the medium 99.
(4) When the current peak position is a position higher than the target position TP of the tension bar 36 and the current peak position is a position higher than the last peak position, the control section 28 adjusts the driving speed of the driving section 33 to driving speed lower than the current driving speed. With this configuration, when the peak position of the tension bar 36 is higher than the target position TP and the peak position of the tension bar 36 tends to rise, the tension bar 36 can be adjusted to swing at a position not too far from the target position TP. For that reason, it is possible to reduce a swing width of the tension bar 36 and a fluctuation amount of the driving speed of the driving section 33. That is, it is possible to suppress fluctuation in the tension applied to the medium 99 by the tension bar 36 and fluctuation in the winding speed of the winding section 32. Therefore, it is possible to reduce variation that occurs in a binding force of the medium 99.
(5) When adjusting the driving speed of the driving section 33 to low driving speed in the last driving speed adjustment and adjusting the driving speed of the driving section 33 to low driving speed in the current driving speed adjustment, the control section 28 adjusts the driving speed of the driving section 33 to driving speed lower than the current driving speed by predetermined speed. With this configuration, when the peak position of the tension bar 36 is higher than the target position TP and the peak position of the tension bar 36 tends to rise, the tension bar 36 can be adjusted to swing at a position not too far from the target position TP. For that reason, it is possible to reduce a swing width of the tension bar 36 and a fluctuation amount of the driving speed of the driving section 33. That is, it is possible to suppress fluctuation in the tension applied to the medium 99 by the tension bar 36 and fluctuation in the winding speed of the winding section 32. Therefore, it is possible to reduce variation that occurs in a binding force of the medium 99.
(6) When the current bottom position is a position lower than the target position TP of the tension bar 36 and the current bottom position is a position lower than the last bottom position, the control section 28 adjusts the driving speed of the driving section 33 to driving speed higher than the current driving speed. With this configuration, when the bottom position of the tension bar 36 is lower than the target position TP and the bottom position of the tension bar 36 tends to fall, the tension bar 36 can be adjusted to swing at a position not too far from the target position TP. For that reason, it is possible to reduce a swing width of the tension bar 36 and a fluctuation amount of the driving speed of the driving section 33. That is, it is possible to suppress fluctuation in the tension applied to the medium 99 by the tension bar 36 and fluctuation in the winding speed of the winding section 32. Therefore, it is possible to reduce variation that occurs in a binding force of the medium 99.
(7) When adjusting the driving speed of the driving section 33 to high driving speed in the last driving speed adjustment and adjusting the driving speed of the driving section 33 to high driving speed in the current driving speed adjustment, the control section 28 adjusts the driving speed of the driving section 33 to driving speed higher than the current driving speed by predetermined speed. With this configuration, when the bottom position of the tension bar 36 is lower than the target position TP and the bottom position of the tension bar 36 tends to fall, the tension bar 36 can be adjusted to swing at a position not too far from the target position TP. For that reason, it is possible to reduce a swing width of the tension bar 36 and a fluctuation amount of the driving speed of the driving section 33. That is, it is possible to suppress fluctuation in the tension applied to the medium 99 by the tension bar 36 and fluctuation in the winding speed of the winding section 32. Therefore, it is possible to reduce variation that occurs in a binding force of the medium 99.
(8) When adjusting the driving speed of the driving section 33, the control section 28 adjusts the driving speed of the driving section 33 to average speed of the last driving speed and the current driving speed when whether the driving speed of the driving section 33 is reduced or increased is different compared with when the driving speed of the driving section 33 is adjusted last time. With this configuration, even when the tension bar 36 repeats rise and fall largely with respect to the target position TP, the tension bar 36 can be adjusted to swing at a position not too far from the target position TP. For that reason, it is possible to reduce a swing width of the tension bar 36 and a fluctuation amount of the driving speed of the driving section 33. That is, it is possible to suppress fluctuation in the tension applied to the medium 99 by the tension bar 36 and fluctuation in the winding speed of the winding section 32. Therefore, it is possible to reduce variation that occurs in a binding force of the medium 99.
(9) When determining that the position of the tension bar 36 detected by the detection section 45 is equal to or higher than the first position P1 higher than the target position TP of the tension bar 36, the control section 28 stops the driving of the driving section 33. With this configuration, when the position of the tension bar 36 is equal to or higher than the first position P1 higher than the target position TP, the position of the tension bar 36 can be rapidly lowered. Therefore, it is possible to control the position of the tension bar 36 not to exceed the first position P1.
(10) When determining that the position of the tension bar 36 detected by the detection section 45 is equal to or lower than the third position P3 lower than the target position TP of the tension bar 36 in a state in which the driving of the driving section 33 is stopped, the control section 28 resumes the driving of the driving section 33. With this configuration, when the position of the tension bar 36 is equal to or lower than the third position P3 lower than the target position TP, the position of the tension bar 36 can be raised toward the target position TP even after the position of the tension bar 36 is rapidly lowered. Therefore, it is possible to control the position of the tension bar 36 not to fall below the third position P3.
(11) When determining that the position of the tension bar 36 detected by the detection section 45 is equal to or lower than the third position P3 in a state in which the driving of the driving section 33 is stopped, the control section 28 resumes the driving of the driving section 33 at the same driving speed as the driving speed before the stop of the driving of the driving section 33. With this configuration, when the position of the tension bar 36 is equal to or lower than the third position P3 lower than the target position TP, the driving speed can be adjusted to the same driving speed as before.
(12) When determining that the position of the tension bar 36 detected by the detection section 45 is equal to or lower than the second position P2 lower than the third position P3, the control section 28 increases the driving speed of the driving section 33 stepwise. With this configuration, when the position of the tension bar 36 is equal to or lower than the second position P2 lower than the target position TP, the position of the tension bar 36 can be raised stepwise. Therefore, it is possible to control the position of the tension bar 36 not to fall below the second position P2.
(13) When determining that the position of the tension bar 36 detected by the detection section 45 is equal to or lower than the second position P2 lower than the target position TP of the tension bar 36, the control section 28 increases the driving speed of the driving section 33 stepwise. With this configuration, when the position of the tension bar 36 is equal to or lower than the second position P2 lower than the target position TP, the position of the tension bar 36 can be raised stepwise. Therefore, it is possible to control the position of the tension bar 36 not to fall below the second position P2.
(14) The printing apparatus 11 includes the upper stopper 41 that restricts the tension bar 36 at the first restriction position RP1 by coming into contact with the tension bar 36, and the first position P1 is located below the first restriction position RP1. With this configuration, when the position of the tension bar 36 is equal to or higher than the first position P1, it is possible to suppress variation in a binding force of the medium 99 due to contact of the tension bar 36 and the upper stopper 41. Therefore, it is possible to reduce variation that occurs in a binding force of the medium 99.
(15) The printing apparatus 11 includes the lower stopper 42 that restricts the tension bar 36 at the second restriction position RP2 by coming into contact with the tension bar 36, and the second position P2 is located above the second restriction position RP2. With this configuration, when the position of the tension bar 36 is equal to or lower than the second position P2, it is possible to suppress variation in a binding force of the medium 99 due to contact of the tension bar 36 and the lower stopper 42. Therefore, it is possible to reduce variation that occurs in a binding force of the medium 99.

### Modifications

The present embodiment can be implemented with the modifications described below. The present embodiment and the following modifications can be implemented in combination with each other as long as no technical inconsistencies are involved.

The control section 28 may continuously set, as the reference peak position, not the immediately preceding peak position but the peak position at the time when the driving speed of the driving section 33 has been adjusted. In the case explained above, in the peak processing in FIG. 6, when determining in step S32 that the position of the tension bar 36 is higher than the reference peak position, the control section 28 may execute the reference peak position update processing in step S38.

The control section 28 may continuously set, as the reference bottom position, not the immediately preceding bottom position but the bottom position at the time when the driving speed of the driving section 33 has been adjusted. In the case explained above, in the bottom processing in FIG. 7, when determining in step S42 that the position of the tension bar 36 is lower than the reference bottom position, the control section 28 may execute the reference bottom position update processing in step S48.

In step S32 in FIG. 6, the control section 28 may determine whether the position of the tension bar 36 is higher than the reference peak position by a prescribed allowable distance. In step S42 in FIG. 7, the control section 28 may determine whether the position of the tension bar 36 is lower than the reference bottom position by a prescribed allowable distance.

When the peak position of the tension bar 36 is higher than the target position TP and the peak position of the tension bar 36 is higher than the reference peak position regardless of the last change flag, the control section 28 may adjust the driving speed of the driving section 33 to driving speed lower than the current driving speed by predetermined speed.

When the bottom position of the tension bar 36 is lower than the target position TP and the bottom position of the tension bar 36 is lower than the reference bottom position regardless of the last change flag, the control section 28 may adjust the driving speed of the driving section 33 to driving speed higher than the current driving speed by predetermined speed. In the cases explained above, the last change flag may not be allocated to the storage section 29. The control section 28 may not execute steps S33 and S35 to S37 in FIG. 6 and steps S43 and S45 to S47 in FIG. 7.

The predetermined speed may not be a predetermined ratio of the current driving speed and may be speed determined in advance.

The target position TP may include a first target position and a second target position. The first target position is a position higher than the target position TP and is a position lower than the first position P1. The second target position is a position lower than the target position TP and is a position higher than the second position P2. In step S31 in FIG. 6, the control section 28 may determine whether the position of the tension bar 36 is higher than the first target position. In step S41 in FIG. 7, the control section 28 may determine whether the position of the tension bar 36 is lower than the second target position. That is, the target position TP may have a predetermined width from the top to the bottom. The control section 28 may determine whether the tension bar 36 is at a position higher or a position lower than the predetermined width of the target position TP. That is, in step S31, the control section 28 may determine whether the tension bar 36 is higher than the top of the width of the target position TP. Similarly, in step S41, the control section 28 may determine whether the tension bar 36 is lower than the bottom of the width of the target position TP.

When determining that the position of the tension bar 36 is equal to or higher than the first position P1, the control section 28 may adjust the driving speed of the driving section 33 to driving speed different from the fourth speed V4 when the position of the tension bar 36 is equal to or lower than the third position P3. In this case, the control section 28 may adjust the driving speed of the driving section 33 to driving speed higher than the fourth speed V4 or may adjust the driving speed of the driving section 33 to driving speed lower than the fourth speed V4 to raise the position of the tension bar 36 from the third position P3.

When determining that the position of the tension bar 36 is equal to or higher than the first position P1, the control section 28 may stop the driving of the driving section 33 until the control section 28 determines that the position of the tension bar 36 is equal to or lower than not the third position P3 but the target position TP. When determining that the position of the tension bar 36 is equal to or higher than the first position P1, the control section 28 may stop the driving of the driving section 33 until the control section 28 determines that the position of the tension bar 36 is equal to or lower than the second position P2.

When determining that the position of the tension bar 36 is equal to or higher than the first position P1, the control section 28 may not stop the driving of the driving section 33 and may adjust the driving speed of the driving section 33 to low speed to lower the position of the tension bar 36 from the first position P1.

When determining that the position of the tension bar 36 is equal to or lower than the second position P2, the control section 28 may adjust the driving speed of the driving section 33 to increase stepwise until the position of the tension bar 36 reaches a position different from the target position TP. The position different from the target position TP may be a position higher than the target position TP or may be a position lower than the target position TP.

When determining that the position of the tension bar 36 is equal to or lower than the second position P2, regardless of the position of the tension bar 36, the control section 28 may adjust, a number of times set in advance, the driving speed of the driving section 33 to increase stepwise.

When determining that the position of the tension bar 36 is equal to or lower than the second position P2, the control section 28 may not increase the driving speed of the driving section 33 stepwise and may adjust the driving speed of the driving section 33 to high speed to raise the position of the tension bar 36 from the second position P2.

The initial driving speed may be speed corresponding to the conveyance speed of the medium 99. For example, the control section 28 may adopt, as the initial driving speed, speed corresponding to the conveyance speed of the medium 99 conveyed by the conveyance section 27.

The control section 28 may calculate a rising amount of the tension bar 36 per unit time based on positions at two or more points of the tension bar 36. The control section 28 may adjust the driving speed of the driving section 33 to low speed based on the rising amount of the tension bar 36 per unit time. The control section 28 may determine the predetermined speed based on the rising amount of the tension bar 36 per unit time.

The control section 28 may calculate a falling amount of the tension bar 36 per unit time based on positions at two or more points of the tension bar 36. The control section 28 may adjust the driving speed of the driving section 33 to high speed based on the falling amount of the tension bar 36 per unit time. The control section 28 may determine the predetermined speed based on the falling amount of the tension bar 36 per unit time.

The printing apparatus 11 may not include the upper stopper 41. In this case, the control section 28 preferably controls the position of the tension bar 36 not to reach the first restriction position RP1 in the first position processing.

The printing apparatus 11 may not include the lower stopper 42. In this case, the control section 28 preferably controls the position of the tension bar 36 not to reach the second restriction position RP2 in the second position processing.

The control section 28 may not execute the first position processing based on an instruction of the user and may not execute the first position processing regardless of the instruction of the user. The control section 28 may not execute the second position processing based on an instruction of the user and may not execute the second position processing regardless of the instruction of the user.

The winding unit 14 may include an adjustment driving section for adjusting the position of the tension bar 36. The adjustment driving section may be a motor that adjusts an angle of the arm 37. In this case, the control section 28 may switch, based on an instruction of the user, whether to adjust the position of the tension bar 36 with the adjustment driving section.

The detection section 45 may directly detect the position of the tension bar 36. The detection section 45 may indirectly detect the position of the tension bar 36. For example, the detection section 45 may detect the position of the tension bar 36 by detecting the position of the arm 37. The detection section 45 may detect the position of the tension bar 36 by detecting a rotation angle of the arm 37. The detection section 45 may be provided at any position if the detection section 45 can detect the position of the tension bar 36. For example, the detection section 45 may be provided on the distal end portion side of the arm 37. The detection section 45 may be provided in the tension bar 36.

The detection section 45 may include a not-illustrated position sensor. The detection section 45 may include one or more position sensors. For example, the position sensor may be an optical sensor. The position sensor is located to be blocked by the tension bar 36 or the arm 37. The position sensor detects the tension bar 36 by being blocked by the tension bar 36 or the arm 37. Accordingly, the detection section 45 detects the position of the tension bar 36.

The detection section 45 may include a not-illustrated distance sensor. For example, the distance sensor is an optical sensor. The distance sensor detects the distance to the tension bar 36. Accordingly, the detection section 45 detects the position of the tension bar 36.

The detection section 45 may include at least one of the encoder, the position sensor, and the distance sensor. That is, the detection section 45 may include one, may include two, or may include all of the encoder, the position sensor, and the distance sensor. For example, the detection section 45 may include only the encoder, may include only the position sensor, or may include only the distance sensor.

The printing unit 12 may include, besides the support section 24, a medium support section that supports the medium 99. The printing unit 12 may include an upstream support section. The upstream support section is located further upstream than the support section 24. The upstream support section supports the medium 99 to thereby guide the medium 99 from the letting-out unit 13 to the support section 24.

The printing unit 12 may include a downstream support section. The downstream support section is located further downstream than the support section 24. The downstream support section supports the medium 99 to thereby guide the medium 99 from the support section 24 to the winding unit 14.

The control section 28 may be provided in the winding unit 14. That is, the winding unit 14 may include the control section 28. The storage section 29 may be provided in the winding unit 14. That is, the winding unit 14 may include the storage section 29.

The control section 28 may be provided in each of the printing unit 12 and the winding unit 14. The storage section 29 may be provided in each of the printing unit 12 and the winding unit 14.

A ratio of a conveyance time of the medium 99 and a stop time of the medium 99 in one intermittent conveyance may be any ratio. The conveyance amount of the medium 99 in one intermittent conveyance may be any conveyance amount. A conveyance amount of the intermittent conveyance per unit time may be any conveyance amount. An interval of one intermittent conveyance may be any interval. The conveyance amount of the medium 99 and the stop time of the medium 99 sometimes change according to printing quality, the width of the medium 99, and the like.

The winding amount per unit time in which the medium 99 is wound by the winding section 32 may be equal to or less than the conveyance amount of the intermittent conveyance per unit time. The driving speed of the driving section 33 may be speed unrelated to the conveyance amount of the medium 99 in one intermittent conveyance and the interval of one intermittent conveyance.

The control section 28 adjusts the driving speed of the driving section 33 based on the position of the tension bar 36 regardless of the conveyance of the medium 99 by the conveyance section 27 but is not limited thereto. For example, the control section 28 may acquire data concerning the conveyance of the medium 99 from the printing unit 12. In this case, the control section 28 may adjust the driving speed of the driving section 33 based on the data concerning the conveyance of the medium 99 and the position of the tension bar 36. The data concerning the conveyance of the medium 99 may be at least any one of the conveyance time of the medium 99 in one intermittent conveyance, the stop time of the medium 99, the conveyance amount of the medium 99 in one intermittent conveyance, the conveyance amount of the intermittent conveyance per unit time, and the interval of one intermittent conveyance.

The medium 99 is not limited to the roll body R1. The medium 99 may be a film or a sheet made of resin, a composite film of resin and metal, a laminated film, woven fabric, nonwoven fabric, a metal foil, a metal film, a ceramic sheet, clothing, or the like.

The liquid can be optionally selected if the liquid can record an image on the medium 99 by adhering to the medium 99. For example, the ink includes ink in which particles of a functional material including a solid matter such as pigment or metal particles are dissolved, dispersed, or mixed in a solvent and includes various compositions such as aqueous ink, oil-based ink, gel ink, and hot melt ink.

The expression "at least any one of" used in the present specification means one or more of desired choices. As an example, when the number of choices is two, the expression "at least any one of" used in the present specification means only one choice or both of the two choices. As another example, when the number of choices is three or more, the expression "at least any one of" used in the present specification means only one choice or a combination of two or more any choices.

### Appendices

Technical ideas figured out from the embodiment and the modifications explained above and action effects thereof are hereinafter be described. The technical ideas and the action effects thereof can be combined with each other within a range where no technical contradictions are involved.

[1] A winding device including: a winding section configured to wind a medium for which intermittent conveyance for repeating one conveyance and stop is performed; a tension bar configured to apply tension to the medium wound by the winding section; a detection section configured to detect a position of the tension bar; a driving section configured to drive the winding section; and a control section configured to control the driving section, wherein the control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar.

With this configuration, even while the intermittent conveyance for repeating one time of the conveyance and the stop is performed, the driving section can be continuously driven at the driving speed adjusted based on the position of the tension bar. Therefore, it is possible to prevent start and stop of the winding of the medium from being repeatedly performed according to the intermittent conveyance of the medium. Therefore, it is possible to reduce variation that occurs in a binding force of the medium.

[2] In the winding device, the driving speed of the driving section is speed corresponding to a conveyance amount of the medium in one intermittent conveyance and an interval of the one intermittent conveyance. With this configuration, the medium can be wound at the speed corresponding to the conveyance amount of the medium in one intermittent conveyance and the interval of the one intermittent conveyance.

[3] In the winding device, a winding amount per unit time in which the medium is wound by the winding section is smaller than a conveyance amount of the medium per unit time. With this configuration, even when the intermittent conveyance is performed for a long time, it is possible to reduce excessive winding of the medium by the winding section when the conveyance of the medium is stopped and it is possible to prevent start and stop of the winding of the medium from being repeatedly performed. Therefore, it is possible to reduce variation that occurs in the binding force of the medium.

[4] In the winding device, the tension bar is displaceable in an up-down direction, and the control section detects a peak position of the tension bar based on the position of the tension bar detected by the detection section and adjusts the driving speed of the driving section to driving speed lower than current driving speed when a current peak position is a position higher than a target position of the tension bar and the current peak position is a position higher than a last peak position.

With this configuration, when the peak position of the tension bar is higher than the target position and the peak position of the tension bar tends to rise, the position of the tension bar can be brought close to the target position by reducing the driving speed. Accordingly, it is possible to reduce a swing width of the tension bar and a fluctuation amount of the driving speed of the driving section. That is, since it is possible to suppress fluctuation in the tension applied to the medium by the tension bar and fluctuation in the winding speed of the winding section, it is possible to reduce variation that occurs in the binding force of the medium.

[5] When adjusting the driving speed of the driving section to low driving speed in the driving speed adjustment performed last time and adjusting the driving speed of the driving section to low driving speed in the driving speed adjustment performed this time, the winding device adjusts the driving speed of the driving section to driving speed lower than the current driving speed by predetermined speed.

With this configuration, when the peak position of the tension bar is higher than the target position and the raising of the peak position of the tension bar is repeated, the driving speed of the driving section can be adjusted to driving speed lower by the predetermined speed. Accordingly, it is possible to continuously drive the driving section even while the intermittent conveyance is performed. Therefore, it is possible to prevent start and stop of the winding of the medium from being repeatedly performed according to the intermittent conveyance of the medium. Therefore, it is possible to reduce variation that occurs in a binding force of the medium.

[6] In the winding device, the tension bar is displaceable in an up-down direction, and the control section detects a bottom position of the tension bar based on the position of the tension bar detected by the detection section and adjusts the driving speed of the driving section to driving speed higher than current driving speed when a current bottom position is a position lower than a target position of the tension bar and the current bottom position is a position lower than a last bottom position.

With this configuration, when the bottom position of the tension bar is lower than the target position and the bottom position of the tension bar falls, the tension bar can be brought close to the target position by increasing the driving speed. Accordingly, it is possible to continuously drive the driving section even while the intermittent conveyance is performed. Therefore, it is possible to prevent start and stop of the winding of the medium from being repeatedly performed according to the intermittent conveyance of the medium. Therefore, it is possible to reduce variation that occurs in a binding force of the medium.

[7] When adjusting the driving speed of the driving section to high driving speed in the driving speed adjustment performed last time and adjusting the driving speed of the driving section to high driving speed in the driving speed adjustment performed this time, the winding device adjusts the driving speed of the driving section to driving speed higher than the current driving speed by predetermined speed.

With this configuration, when the bottom position of the tension bar is lower than the target position and lowering of the bottom position of the tension bar is repeated, the driving speed of the driving section can be adjusted to driving speed higher by the predetermined speed. Accordingly, it is possible to continuously drive the driving section even while the intermittent conveyance is performed. Therefore, it is possible to prevent start and stop of the winding of the medium from being repeatedly performed according to the intermittent conveyance of the medium. Therefore, it is possible to reduce variation that occurs in a binding force of the medium.

[8] In the winding device, the tension bar is displaceable in an up-down direction, and the control section detects a peak position of the tension bar and a bottom position of the tension bar based on the position of the tension bar detected by the detection section, adjusts the driving speed of the driving section to driving speed lower than current driving speed when a current peak position is a position higher than a target position of the tension bar and the current peak position is a position higher than a last peak position, adjusts the driving speed of the driving section to driving speed higher than the current driving speed when a current bottom position is a position lower than the target position of the tension bar and the current bottom position is a position lower than a last bottom position, and adjusts the driving speed of the driving section to average speed of the last driving speed and the current driving speed when whether the driving speed of the driving section is reduced or increased is different compared with when the driving speed of the driving section was adjusted last time.

With this configuration, when a case in which the peak position of the tension bar rises and a case in which the bottom position of the tension bar falls are repeated, the driving speed of the driving section can be adjusted to the average speed of the last driving speed and the current driving speed. Accordingly, it is possible to continuously drive the driving section even while the intermittent conveyance is performed. Therefore, it is possible to prevent start and stop of the winding of the medium from being repeatedly performed according to the intermittent conveyance of the medium. Therefore, it is possible to reduce variation that occurs in a binding force of the medium.

[9] In the winding device, when determining that the position of the tension bar detected by the detection section is equal to or higher than a first position higher than a target position of the tension bar, the control section stops the driving of the driving section.

With this configuration, when the position of the tension bar is equal to or higher than the first position higher than the target position, the driving of the driving section can be stopped. Accordingly, it is possible to rapidly lower the position of the tension bar. Therefore, it is possible to control the position of the tension bar not to exceed the first position.

[10] In the winding device, when determining that the position of the tension bar detected by the detection section is equal to or lower than a third position lower than the target position of the tension bar in a state in which the driving of the driving section is stopped, the control section resumes the driving of the driving section.

With this configuration, when the position of the tension bar is equal to or lower than the third position lower than the target position, the driving of the driving section can be resumed. Accordingly, even after the position of the tension bar is rapidly lowered, it is possible to raise the position of the tension bar toward the target position. Therefore, it is possible to control the position of the tension bar not to fall below the third position.

[11] In the winding device, when determining that the position of the tension bar detected by the detection section is equal to or lower than the third position in the state in which the driving of the driving section is stopped, the control section resumes the driving of the driving section at the same driving speed as the driving speed before the stop of the driving of the driving section. With this configuration, when the position of the tension bar is equal to or lower than the third position lower than the target position, the driving speed of the driving section can be adjusted to the same driving speed as before.

[12] In the winding device, when determining that the position of the tension bar detected by the detection section is equal to or lower than a second position lower than the third position, the control section increases the driving speed of the driving section stepwise.

With this configuration, when the position of the tension bar is equal to or lower than the second position lower than the target position, the driving speed of the driving section can be increased stepwise. Accordingly, it is possible to raise the position of the tension bar stepwise. Therefore, it is possible to control the position of the tension bar not to fall below the second position.

In addition, when the position of the tension bar is equal to or lower than the third position higher than the second position after the position of the tension bar is equal to or higher than the first position, it is possible to resume the driving of the driving section.

[13] In the winding device, when determining that the position of the tension bar detected by the detection section is equal to or lower than a second position lower than a target position of the tension bar, the control section increases the driving speed of the driving section stepwise.

With this configuration, when the position of the tension bar is equal to or lower than the second position lower than the target position, the driving speed of the driving section can be increased stepwise. Accordingly, it is possible to raise the position of the tension bar stepwise. Therefore, it is possible to control the position of the tension bar not to fall below the second position.

[14] The winding device includes an upper stopper configured to restrict the tension bar at a first restriction position by coming into contact with the tension bar, and the first position is located below the first restriction position.

With this configuration, when the position of the tension bar is equal to or higher than the first position, the position of the tension bar can be rapidly lowered by stopping the driving of the driving section before the tension bar comes into contact with the upper stopper. Accordingly, it is possible to prevent the tension bar from coming into contact with the upper stopper. For this reason, it is possible to suppress variation in the binding force of the medium due to contact of the tension bar and the upper stopper. Therefore, it is possible to reduce variation that occurs in a binding force of the medium.

[15] The winding device includes a lower stopper configured to restrict the tension bar at a second restriction position by coming into contact with the tension bar, and the second position is located above the second restriction position.

With this configuration, when the position of the tension bar is equal to or lower than the second position, the position of the tension bar can be raised stepwise by increasing the driving speed of the driving section stepwise before the tension bar comes into contact with the lower stopper. Accordingly, it is possible to prevent the tension bar from coming into contact with the lower stopper. For this reason, it is possible to suppress variation in the binding force of the medium due to contact of the tension bar and the lower stopper. Therefore, it is possible to reduce variation that occurs in a binding force of the medium.

[16] A printing apparatus including: a conveyance section configured to perform intermittent conveyance for a medium for repeating one conveyance and stop; a printing section configured to perform printing on the medium in a state in which the medium is stopped; a winding section configured to wind the medium for which the intermittent conveyance is performed; a tension bar configured to apply tension to the medium wound by the winding section; a detection section configured to detect a position of the tension bar; a driving section configured to drive the winding section; and a control section configured to control the driving section, wherein the control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar. With this configuration, it is possible to achieve the same effects as the effects in [1].

What is claimed is:

1. A winding device comprising:
a winding section configured to wind a medium for which intermittent conveyance for repeating one conveyance and stop is performed;
a tension bar configured to apply tension to the medium wound by the winding section;
a detection section configured to detect a position of the tension bar;
a driving section configured to drive the winding section; and
a control section configured to control the driving section, wherein
the control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar.

2. The winding device according to claim 1, wherein the driving speed of the driving section is speed corresponding to a conveyance amount of the medium in one intermittent conveyance and an interval of the one intermittent conveyance.

3. The winding device according to claim 2, wherein a winding amount per unit time in which the medium is wound by the winding section is smaller than a conveyance amount of the medium per unit time.

4. The winding device according to claim 1, wherein
the tension bar is displaceable in an up-down direction, and
the control section detects a peak position of the tension bar based on the position of the tension bar detected by the detection section and adjusts the driving speed of the driving section to driving speed lower than current driving speed when a current peak position is a position higher than a target position of the tension bar and the current peak position is a position higher than a last peak position.

5. The winding device according to claim 4, wherein, when adjusting the driving speed of the driving section to low driving speed in the driving speed adjustment performed last time and adjusting the driving speed of the driving section to low driving speed in the driving speed adjustment performed this time, the winding device adjusts the driving speed of the driving section to driving speed lower than the current driving speed by predetermined speed.

6. The winding device according to claim 1, wherein
the tension bar is displaceable in an up-down direction, and
the control section detects a bottom position of the tension bar based on the position of the tension bar detected by the detection section and adjusts the driving speed of the driving section to driving speed higher than current driving speed when a current bottom position is a position lower than a target position of the tension bar and the current bottom position is a position lower than a last bottom position.

7. The winding device according to claim 6, wherein, when adjusting the driving speed of the driving section to high driving speed in the driving speed adjustment performed last time and adjusting the driving speed of the driving section to high driving speed in the driving speed adjustment performed this time, the winding device adjusts the driving speed of the driving section to driving speed higher than the current driving speed by predetermined speed.

8. The winding device according to claim 1, wherein
the tension bar is displaceable in an up-down direction, and
the control section detects a peak position of the tension bar and a bottom position of the tension bar based on the position of the tension bar detected by the detection section, adjusts the driving speed of the driving section to driving speed lower than current driving speed when a current peak position is a position higher than a target position of the tension bar and the current peak position is a position higher than a last peak position, adjusts the driving speed of the driving section to driving speed higher than the current driving speed when a current bottom position is a position lower than the target position of the tension bar and the current bottom position is a position lower than a last bottom position, and adjusts the driving speed of the driving section to average speed of the last driving speed and the current driving speed when whether the driving speed of the driving section is reduced or increased is different compared with when the driving speed of the driving section was adjusted last time.

9. The winding device according to claim 1, wherein, when determining that the position of the tension bar detected by the detection section is equal to or higher than a first position higher than a target position of the tension bar, the control section stops the driving of the driving section.

10. The winding device according to claim 9, wherein, when determining that the position of the tension bar detected by the detection section is equal to or lower than a third position lower than the target position of the tension bar in a state in which the driving of the driving section is stopped, the control section resumes the driving of the driving section.

11. The winding device according to claim 10, wherein, when determining that the position of the tension bar detected by the detection section is equal to or lower than the third position in the state in which the driving of the driving section is stopped, the control section resumes the driving of the driving section at the same driving speed as the driving speed before the stop of the driving of the driving section.

12. The winding device according to claim 10, wherein, when determining that the position of the tension bar detected by the detection section is equal to or lower than a second position lower than the third position, the control section increases the driving speed of the driving section stepwise.

13. The winding device according to claim 1, wherein, when determining that the position of the tension bar detected by the detection section is equal to or lower than a second position lower than a target position of the tension bar, the control section increases the driving speed of the driving section stepwise.

14. The winding device according to claim 9, further comprising an upper stopper configured to restrict the tension bar at a first restriction position by coming into contact with the tension bar, wherein
the first position is located below the first restriction position.

15. The winding device according to claim 12, further comprising a lower stopper configured to restrict the tension bar at a second restriction position by coming into contact with the tension bar, wherein
the second position is located above the second restriction position.

16. A printing apparatus comprising:
a conveyance section configured to perform intermittent conveyance for a medium for repeating one conveyance and stop;
a printing section configured to perform printing on the medium in a state in which the medium is stopped;
a winding section configured to wind the medium for which the intermittent conveyance is performed;
a tension bar configured to apply tension to the medium wound by the winding section;
a detection section configured to detect a position of the tension bar;
a driving section configured to drive the winding section; and
a control section configured to control the driving section, wherein
the control section is capable of carrying out driving speed adjustment for adjusting driving speed of the driving section based on the position of the tension bar detected by the detection section and, while the intermittent conveyance for the medium is performed, in a state in which the tension bar applies the tension to the medium, continuously drives the driving section at the driving speed adjusted based on the position of the tension bar.
